(19) United States
(12) Patent Application Publication
(10) Pub. No.: US 2018/0207831 A1
(43) Pub. Date: Jul. 26, 2018

(54) CIRCULAR SAW

(71) Applicant: Nanjing Chervon Industry Co., Ltd., Nanjing (CN)

(72) Inventors: Fukinuki Masatoshi, Nanjing (CN); Hongbin Wang, Nanjing (CN)

(21) Appl. No.: 15/863,176

(22) Filed: Jan. 5, 2018

(30) Foreign Application Priority Data
Jan. 22, 2017 (CN) 201720083382.8

(51) Int. Cl. B27B 9/00; B25F 5/02; H01M 2/10

(52) U.S. Cl. CPC B27B 9/00; H01M 2220/30; H01M 2/1022; B25F 5/02

(57) ABSTRACT

A circular saw includes a cutting piece, a motor, a battery pack and an operating handle. The cutting piece is configured to cut a workpiece. The motor is configured to drive the cutting piece to rotate around a central axis. The battery pack is configured to supply power for the motor. The operating handle is used for a user to operate the circular saw. The motor, the battery pack and the operating handle are arranged at a same side of the cutting piece and are distributed substantially along a straight line. The battery pack is further arranged between the motor and the operating handle.

### RELATED APPLICATION INFORMATION

This application claims the benefit of CN 201720083382.8, filed on Jan. 22, 2017, the disclosure of which is incorporated herein by reference in its entirety.

### TECHNICAL FIELD

The subject disclosure relates to a circular saw, and particularly relates to an electric circular saw.

### BACKGROUND

An electric circular saw is a power tool which performs sawing operation by driving a saw blade, and has characteristics of safety and reliability, high working efficiency and the like. The electric circular saw generally includes a housing, a motor, a bottom plate, an angle regulating mechanism, a depth regulating structure and a guide apparatus, wherein the housing is further formed with a handle for a user to grip. However, a direct current electric circular saw generally further includes a battery pack for supplying power for the motor. In an existing electric circular saw, the battery pack is generally arranged on a rear side of the handle, so that the entire machine has large size and heavy weight, causing inconvenience of use for the user.

### SUMMARY

To solve defects of existing saws, the following describes a circular saw having a reasonable structure and a small size.

To realize the above purpose, the subject disclosure describes a circular saw that includes a cutting piece, a motor, a battery pack and an operating handle. The cutting piece is configured to implement a cutting function. The motor is configured to drive the cutting piece to rotate around a central axis. The battery pack is configured to supply power for the motor. The operating handle is used for a user to operate the circular saw. The motor, the battery pack and the operating handle are arranged at a same side of the cutting piece and are distributed substantially along a straight line. The battery pack is further arranged between the motor and the operating handle,

Further, the circular saw may include a housing configured to accommodate the motor, wherein the battery pack is detachably connected to the housing.

Further, the housing may be formed with the operating handle.

Further, the circular saw may include a housing formed with an inner cavity for accommodating the motor, wherein the housing is formed with an inserting groove for detachably inserting the battery pack outside the inner cavity.

Further, the housing may be formed with the operating handle.

Further, the inserting groove may be internally provided with a guide rib configured to guide the battery pack to insert the battery pack into the inserting groove along a first direction where the operating handle is formed with a grip portion used for the user to grip and wherein the grip portion is formed by extending substantially along a direction parallel to the first direction.

Further, the circular saw may include a housing configured to accommodate the motor; wherein the battery pack is detachably and slidably connected to the housing.

Further, the circular saw may include a supporting seat formed with a contact plane configured to contact with a to-be-cut piece wherein the motor is rotatably connected to the supporting seat and a direction along which the battery pack slides relative to the housing is obliquely intersected with the contact plane.

Further, the battery pack may be located between the operating handle and the central axis of the cutting piece.

Further, the cutting piece is preferably a circular saw blade.

The following thus describes a beneficial effect that the circular saw has a reasonable structure, a small size and a light weight.

### BRIEF DESCRIPTION OF DRAWINGS

FIG. 1 is a three-dimensional diagram illustrating an exemplary circular saw;

FIG. 2 is a planar diagram illustrating the circular saw in FIG. 1;

FIG. 3 is a three-dimensional diagram illustrating the circular saw in FIG. 1 when a battery pack is separated from a housing;

FIG. 4 is a planar diagram illustrating the circular saw in FIG. 1 when the battery pack is separated from the housing; and

FIG. 5 is a three-dimensional diagram illustrating the circular saw in FIG. 1 when part of the housing is removed.

### DETAILED DESCRIPTION

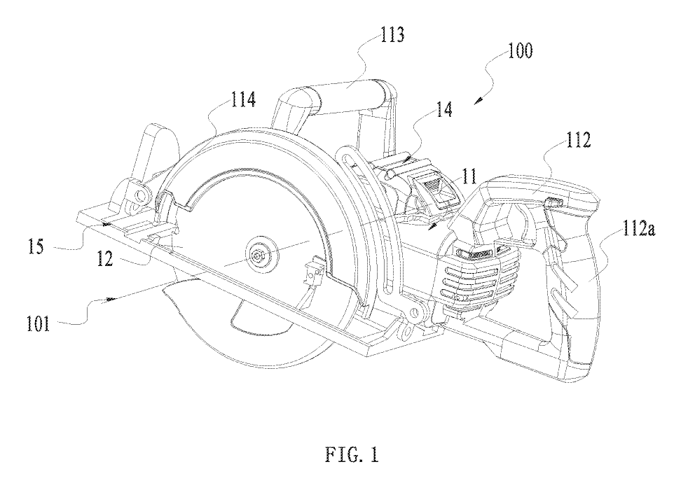

A circular saw 100 shown in FIG. 1 may be specifically a tool for cutting. For example, the circular saw 100 is an electric circular saw.

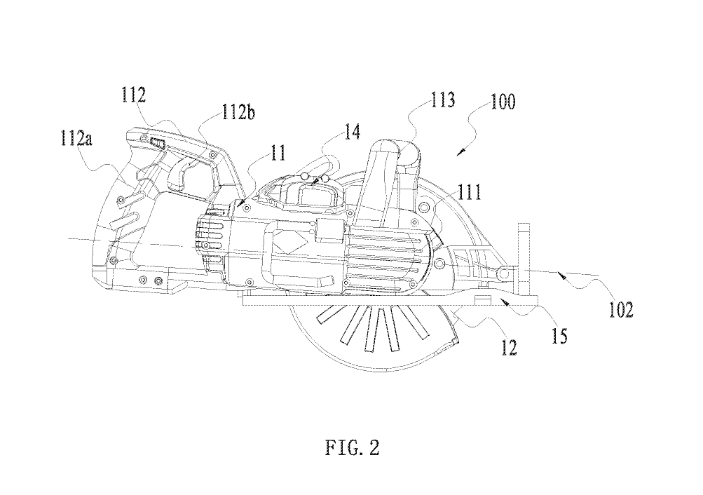

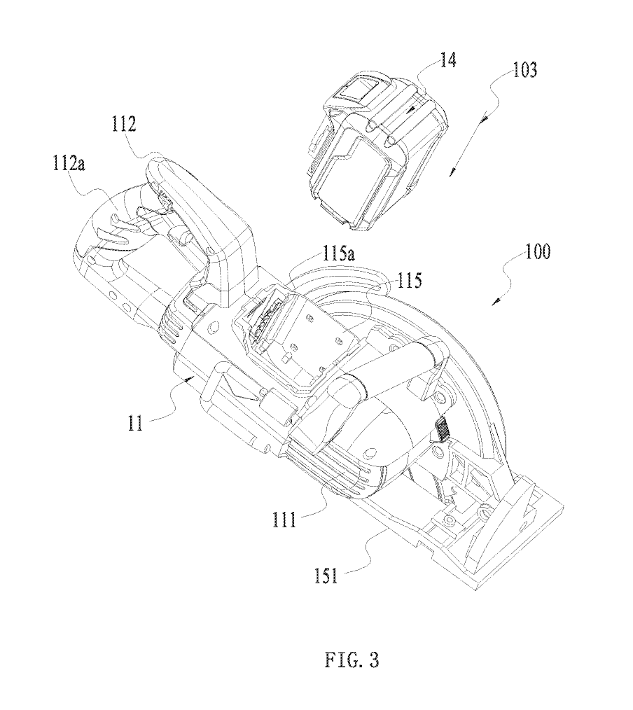

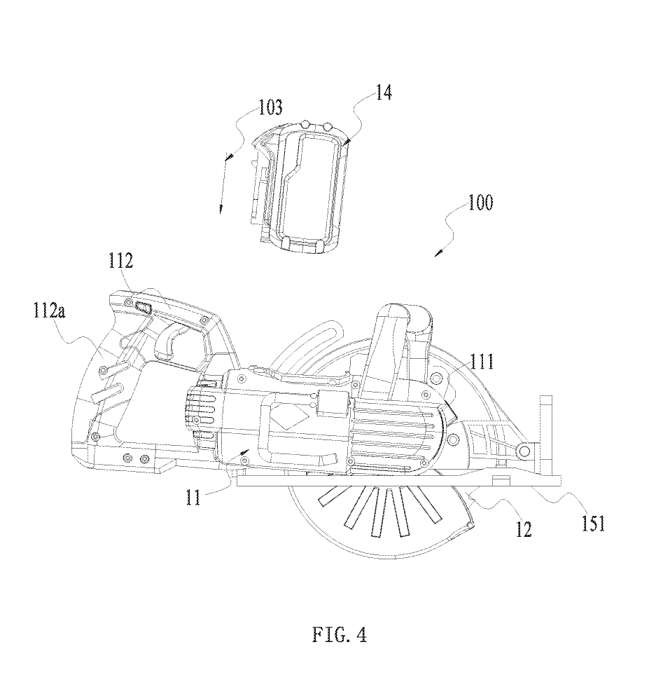

As shown in FIG. 1 to FIG. 5, the circular saw 100 includes a housing 11, a cutting piece 12, a motor 13, a battery pack 14 and a supporting seat 15, wherein the motor 13 is arranged in the housing 11. For the electric circular saw, the cutting piece 12 may be specifically a circular saw blade, and the motor 13 is a motor for outputting power.

The housing 11 includes an accommodating portion 111 for accommodating the motor 13. The accommodating portion 111 is formed with an inner cavity for placing the motor 13. The housing 11 is further formed with an operating handle 112, an auxiliary handle 113, a protective cover 114 and other structures. The accommodating portion 111 is located at one side of the cutting piece 12. The operating handle 112 is used for a user to operate the circular saw 100. An operating switch 112b for controlling start and stop of the circular saw 100 is further arranged on the operating handle 112. The auxiliary handle 113 is used for the user to assist in gripping the circular saw 100. The protective cover 114 is used for at least partially encircling the cutting piece 12 to protect safety of environment and the user.

The cutting piece 12 is configured to implement a cutting function. The motor 13 is configured to drive the cutting piece 12 to rotate around a central axis 101. The battery pack 14 is configured to supply power for the motor 13, wherein the operating handle 112, the motor 13 and the battery pack 14 are arranged at a same side of the cutting piece 12 and are distributed along a first straight line 102. For the electric circular saw, the operating handle 112, the motor 13 and the battery pack 14 are further arranged at one side of both sides of the circular saw blade along a direction of the central axis 101, wherein the battery pack 14 is further arranged between the motor 13 and the operating handle 112. Further, the battery pack 14 is further arranged between the operating handle 112 and the central axis 101 of the cutting piece 12. In this way, not only does the circular saw 100 occupy a small space, have a compact structure and a light weight, but also allows the user to balance performance of the circular saw 100 on the basis of not changing an operating habit. In addition, for the electric circular saw, the motor 13 may be an outer rotor brushless motor. In this way, a size of the accommodating portion 111 of the housing 11 is greatly reduced. At this moment, the housing 11 has a redundant space for placing the battery pack 14. From a perspective of human engineering, the battery pack 14 is arranged between the operating handle 112 and the motor 13 so that a distance between the operating handle 112 and the auxiliary handle 113 is reasonable, and thus the user can grip the circular saw 100 more stably. In addition, the position of the battery pack 14 further ensures that a center of gravity of the circular saw 100 is located between the operating handle 112 and the auxiliary handle 113, thereby further improving grip stability of the user.

Specifically, the housing 11 is formed with an inserting groove 115 outside the inner cavity. In other words, the housing 11 is sunk from an outer wall to form an inserting groove 115 which is open outwards. The inserting groove 115 is arranged between the operating handle 112 and the accommodating portion 111. The inserting groove 115 is configured to detachably insert the battery pack 14 to the housing 11. A guide rib 115a is further arranged in the inserting groove 115. The guide rib 115a is configured to guide the battery pack 14 to slidably insert the battery pack 14 into the inserting groove 115 along a first direction 103. The operating handle 112 is formed with a grip portion 112a used for the user to grip. The grip portion 112a is formed by extending substantially along a direction parallel to the first direction 103. In this way, the user can detachably insert the battery pack 14 into the inserting groove 115 along a first direction 103 and, after the battery pack 14 is combined to the housing 11, the battery pack 14 is located between the operating handle 112 and the motor 13. In addition, the first direction 103 along which the battery pack 14 is inserted into the inserting groove 115 is basically parallel to the extension direction of the grip portion 112a, and is also perpendicular to the direction of the central axis 101 around which the cutting piece 12 rotates, thereby facilitating the user in inserting the battery pack 14 at the time of placing the circular saw 100 on a working table without lifting the circular saw 100, and further facilitating user operation.

The motor 13 further includes a driving shaft 131 for outputting power. In the present example, the direction of the rotating axis of the driving shaft 131 is parallel to the direction of the central axis 101. Of course, in other embodiments, the direction of the rotating axis of the driving shaft 131 can also be perpendicular to the direction of the central axis 101. At this moment, a reversible transmission mechanism may be arranged between the motor 13 and the cutting piece 12. In fact, as long as a position of the motor 13, a position of the battery pack 14 and a position of the operating handle 112 are arranged basically in a straight line, it is regarded as a technical solution to the aforementioned problems.

The supporting seat 15 is configured to support the whole circular saw 100. The supporting seat 15 is further formed with a contact plane 151 configured to contact with a to-be-cut piece 12. A whole formed by the housing 11, the motor 13 and the cutting piece 12 is located at an upper side of the contact plane 151. The whole further forms a rotatable connection with the supporting seat 15.

The direction of a first straight line 102 along which the operating handle 112, the battery pack 14 and the motor 13 are arranged is further obliquely intersected with the contact plane 151. The first direction 103 along which the battery pack 14 slides relative to the housing 11 is further obliquely intersected with the contact plane 151, wherein an included angle formed by intersection of the direction of the first straight line 102 and the contact plane 151 is greater than 0 degree and less than or equal to 20 degrees. Further, the included angle is greater than 0 degree and less than or equal to 10 degrees. In this way, not only can the user conveniently grip the operating handle 112 to operate the circular saw 100, but also the circular saw 100 realizes reasonable structure and good balance.

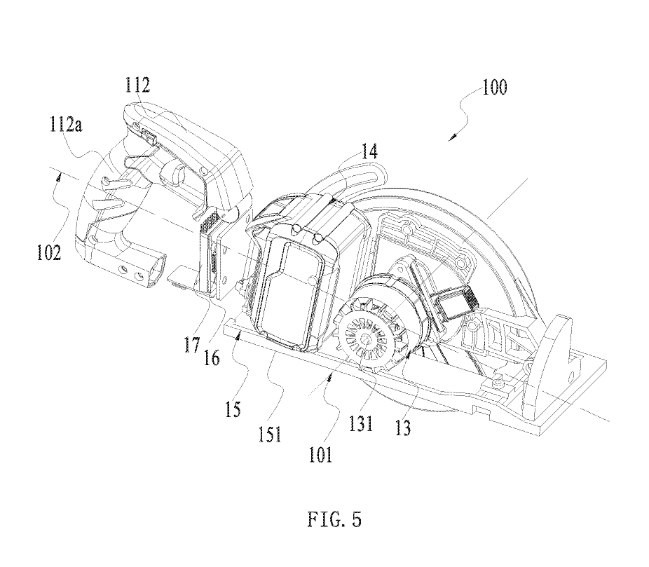

As shown in FIG. 5, the circular saw 100 further includes a circuit board 16 configured to control the circular saw 100, as well as a heat radiating fin 17 configured to radiate heat for the circuit board 16, wherein the circuit board 16 and the heat radiating fin 17 are arranged between the operating handle 112 and the battery pack 14. A position of the circuit board 16 is set in the direction of the first straight line 102 and a position of the heat radiating fin 17 is also set in the direction of the first straight line 102. Namely, the motor 13, the battery pack 14, the circuit board 16, the heat radiating fin 17 and the operating handle 112 are distributed substantially along the first straight line 102. In this way, a heat radiating channel which can successively flow through the motor 13, the battery pack 14, the circuit board 16 and the heat radiating fin 17 basically along the direction of the first straight line 102 can be formed in the housing 11, thereby improving heat radiating effect of the circular saw 100.

The above shows and describes a basic principle, main features and advantages of the subject device. Those skilled in the art should understand that above described examples do not limit the invention hereinafter claimed in any form. Technical solutions obtained by adopting equivalent replacements or equivalent transformations are intended to fall within a protection scope of claimed invention.

What is claimed is:

1. A circular saw, comprising:
a cutting piece configured to cut a workpiece;
a motor configured to drive the cutting piece to rotate around a central axis;
a battery pack configured to supply power for the motor; and
an operating handle used by a user to operate the circular saw;
wherein the motor, the battery pack and the operating handle are arranged at a same side of the cutting piece and are distributed substantially along a straight line and the battery pack is arranged between the motor and the operating handle.

2. The circular saw according to claim 1, further comprising a housing configured to accommodate the motor wherein the battery pack is detachably connected to the housing.

3. The circular saw according to claim 2, wherein the housing is further formed with the operating handle.

4. The circular saw according to claim 1, further comprising a housing formed with an inner cavity for accommodating the motor wherein the housing is formed with an inserting groove for detachably inserting the battery pack outside the inner cavity.

5. The circular saw according to claim 4, wherein the housing is further formed with the operating handle.

6. The circular saw according to claim 4, wherein the inserting groove is internally provided with a guide rib configured to guide the battery pack to insert the battery pack into the inserting groove along a first direction, the operating handle is formed with a grip portion used for the user to grip, and the grip portion is extends substantially along a direction parallel to the first direction.

7. The circular saw according to claim 1, further comprising a housing configured to accommodate the motor wherein the battery pack is detachably and slidably connected to the housing.

8. The circular saw according to claim 7, further comprising a supporting seat formed with a contact plane configured to contact with the workpiece wherein the motor is rotatably connected to the supporting seat and a direction along which the battery pack slides relative to the housing is obliquely intersected with the contact plane.

9. The circular saw according to claim 1, wherein the battery pack is located between the operating handle and the central axis of the cutting piece.

10. The circular saw according to claim 1, wherein the cutting piece is a circular saw blade.
